(19) United States
(12) Patent Application Publication
(10) Pub. No.: US 2016/0258607 A1
(43) Pub. Date: Sep. 8, 2016

(54) FLEXIBLE WORK LIGHT

(71) Applicant: Power Probe TEK, LLC, Brea, CA (US)

(72) Inventor: Joshua Carton, Wilmington, CA (US)

(73) Assignee: Power Probe TEK, LLC, Brea, CA (US)

(21) Appl. No.: 15/061,881

(22) Filed: Mar. 4, 2016

Related U.S. Application Data
(60) Provisional application No. 62/129,515, filed on Mar. 6, 2015.

(51) Int. Cl. F21V 21/32; F21L 4/00; F21L 14/02; F21V 8/00

(52) U.S. Cl. CPC F21V 21/32; G02B 6/0006; G02B 6/001; F21L 4/00; F21L 14/026; F21Y 2101/02

(57) ABSTRACT

An apparatus and a method are provided for a flexible work light comprising an elongate member comprising a translucent material capable of being shaped. A lighting source is housed within, and protected by, the elongate member. One or more support members are attached to the lighting source and extend from a proximal portion to a distal portion of the work light. An electronics housing and a plurality of end caps are respectively disposed on the proximal and distal portions of the work light.

### PRIORITY

This application claims the benefit of and priority to U.S. Provisional Application, entitled “Flexible Work Light,” filed on Mar. 6, 2015 having application Ser. No. 62/129,515.

### FIELD

The field of the present disclosure generally relates to work lights. More particularly, the field of the invention relates to an apparatus and a method for a flexible work light that may be manipulated into various advantageous shapes.

### BACKGROUND

An automotive technician is often responsible for performing maintenance on vehicles, as well as diagnosing problems with vehicles. For example, an automotive technician may perform engine oil changes and tune-ups to keep vehicles in good working condition. Automotive technicians typically use a broad range of tools in their work, such as wrenches, jacks, pressures gauges, computers, various lighting instruments, and the like. Because technicians usually work in tight spaces that may also be dark, having proper lighting is crucial. It will be appreciated that having effective lighting is important for safety of the technician, as well as enabling the technician to accurately see and better perform work on the vehicle.

As will be appreciated by those skilled in the art, one way to illuminate a work area is via use of a linear light source, such as a flashlight. A drawback to using a flashlight, however, is that the flashlight must be continuously pointed at the work area. Using a flashlight is cumbersome because the flashlight often must be continuously held in one hand, thus limiting the technician's ability to work, and because flashlights generally illuminate small areas, and thus do not provide adequate illumination across a broad work area. Furthermore, flashlights and other such lighting systems typically cast shadows in and/or around the work area, hindering visibility and creating a hazardous work environment for the technician. Another drawback to using flashlights is they can become hazardously hot, and if dropped, may ignite a fire when exposed to flammable materials that are often found in a typical garage.

What is needed, therefore, is a flexible hold work light that provides light and is capable of being manipulated in and around work areas. What is further needed is a work light that is configured to be desirably shaped by a user and retains the shape until being reshaped by the user. Finally, there is a need for a work light that remains cool to the touch and thus is incapable of igniting flammable materials in the work environment.

### SUMMARY

In a most general aspect, the invention provides a flexible lighting instrument that may be bent and manipulated to illuminate a workspace. In one embodiment, the flexible lighting instrument can be bent to a desired shape that is retained until reshaped by the user. In one embodiment, the flexible lighting instrument may be battery operated for wireless operation. In one embodiment, an external power source such as a car battery or AC source may be implemented.

In one aspect, the invention provides for a flexible work light, comprising: an elongate member comprised of a translucent material capable of being shaped; a lighting source housed within the elongate member and protected thereby; one or more support members attached to the lighting source and extending from a proximal portion to a distal portion of the work light; an electronic housing; and a plurality of end caps disposed on a proximal and distal portions of the work light.

In another aspect, the electronic housing includes a plurality of user controls. In another aspect, the lighting source comprises of LEDs. In another aspect, the lighting source comprises of a fiber optic light guide. In another aspect, the lighting source further comprises of LEDs.

In yet another aspect, the support members are comprised of one or more steel flats. In another aspect, the support members comprise of one or more wires. In another aspect, the flexible work light further includes an interface to couple with an external power supply.

In one aspect, the elongate member is comprised of PVC. The flexible work light of wherein the elongate member is comprised of epoxy. In another aspect, the flexible work light is capable of being configured to a particular shape, and maintaining the shape until reconfigured by a user.

In another aspect, the invention provides a flexible work light, comprising: an elongate member capable of being configured to a particular shape or manipulated into a multiplicity of shapes; a lighting source disposed within the elongate member and attached to one or more support members; an electronics housing including a plurality of user controls; and a plurality of end caps disposed on a proximal and distal portions of the work light.

In one aspect, the lighting source comprises of LEDs. The flexible work light, wherein the lighting source further comprises of LEDs. In one aspect, the support members comprise of one or more wires. In one aspect, the electronic housing includes leads that extend and are capable of coupling to an external power source. In one aspect, the electronic housing includes a battery.

In another aspect, the invention provides a method of manufacturing a flexible work light, comprising: providing a flexible elongate member; adhering one or more lighting sources to one or more support members; coupling electronics housed within an electronics housing with the lighting sources; attaching the elongate member to the electronic housing; attaching the elongate member to the electronics housing; and disposing end caps on the proximal and distal ends of the flexible work light. In one aspect, the flexible elongate member is comprised of PVC. In one aspect, the electronics housing includes a plurality of user controls.

While the invention has been described in terms of particular variations and illustrative figures, those of ordinary skill in the art will recognize that the invention is not limited to the variations or figures described. In addition, where methods and steps described above indicate certain events occurring in certain order, those of ordinary skill in the art will recognize that the ordering of certain steps may be modified and that such modifications are in accordance with the variations of the invention. Additionally, certain of the steps may be performed concurrently in a parallel process when possible, as well as performed sequentially as described above. To the extent there are variations of the invention, which are within the spirit of the disclosure or equivalent to the inventions found in the claims, it is the intent that this patent will cover those variations as well. Therefore, the present disclosure is to be understood as not limited by the specific embodiments described herein, but only by scope of the appended claims.

### BRIEF DESCRIPTION OF THE DRAWINGS

The drawings refer to embodiments of the present disclosure in which:

FIG. 1A is a perspective view of an exemplary embodiment of a flexible work light in accordance with the principles of one embodiment the present disclosure;

FIG. 1B is a perspective view of an exemplary embodiment of a flexible work light that has been manipulated into a desired shape by a user, according to the present disclosure;

FIG. 2 is a perspective view of the various components that may comprise the flexible work light of one embodiment the present disclosure;

FIGS. 3A-3C illustrate perspective views of the flexible work light illustrated in FIGS. 1-2 manipulated by a user into exemplary desired shapes in accordance with the present disclosure; and

FIGS. 4A-4B illustrate exemplary use environments wherein a flexible work light is used to illuminate a work area, according to the present disclosure.

While the present disclosure is subject to various modifications and alternative forms, specific embodiments thereof have been shown by way of example in the drawings and will herein be described in detail. The invention should be understood to not be limited to the particular forms disclosed, but on the contrary, the intention is to cover all modifications, equivalents, and alternatives falling within the spirit and scope of the present disclosure.

### DETAILED DESCRIPTION

In the following description, numerous specific details are set forth in order to provide a thorough understanding of the present disclosure. It will be apparent, however, to one of ordinary skill in the art that the invention disclosed herein may be practiced without these specific details. Thus, the specific details set forth are merely exemplary. The specific details may be varied from and still be contemplated to be within the spirit and scope of the present disclosure. The term “coupled” is defined as meaning connected either directly to the component or indirectly to the component through another component. Further, as used herein, the terms “about,” “approximately,” or “substantially” for any numerical values or ranges indicate a suitable dimensional tolerance that allows the part or collection of components to function for its intended purpose as described herein.

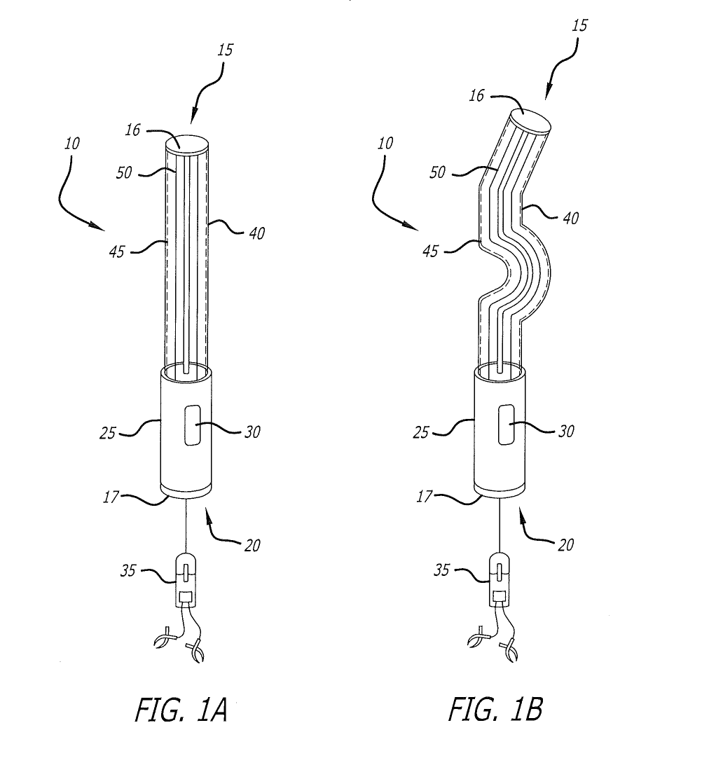

FIG. 1A shows an exemplary embodiment of a flexible work light 10 in accordance with one embodiment of the present disclosure. The work light 10 comprises a distal portion 15 and a proximal portion 20. In the embodiment illustrated in FIG. 1A, the distal portion 15 comprises an end cap 16, and the proximal portion 20 comprises an end cap 17. In one embodiment, an electronics housing 25 is included at the proximal portion 20. In yet another embodiment, the electronics housing 25 comprises an interface for connecting to leads 35. In one embodiment, the work light 10 comprises an elongate member 40 that extends longitudinally from the proximal portion 20 to the distal portion 15 of the work light. In one embodiment, the elongate member 40 operates as a cover for one or more light sources 45 and one or more support members 50. In one embodiment, the work light 10 is water and dust resistant. In yet another embodiment, the work light 10 is impact resistant and suitable for heavy use, especially in workspaces wherein the work light 10 may be subjected to otherwise damaging forces—such as those forces often ocurring at construction sites and in automotive repair shops.

In one embodiment, the electronics housing 25 comprises various electronic circuitry and component, such as by way of non-limiting example, voltage regulators, a power supply, control circuitry, wiring, and the like. In one embodiment, the electronics housing 25 may further comprise a portion for a disposable or rechargeable battery. In another embodiment, the electronics housing 25 may include a connective interface for leads 35 that are configured to couple the work light 10 with an external power source. In yet another embodiment, the leads 35 may be in the form of banana clips, or other similar fasteners, such that the leads may be coupled to a 12-volt (V) automobile battery. For example, the clips may be of any type, including but not necessarily limited to, closed screw type, or open screw type, and may also be known as plugs or banana plugs. It will be appreciated that any type of plug or clip may be used with the leads 35.

In one embodiment, the electronics housing 25 may be comprised of an aluminum-based material. In one embodiment, the electronics housing 25 may be comprised of a thermoplastic polymer, such as acrylonitrile butadiene styrene (ABS). In one embodiment, the electronics housing 25 may be comprised of a combination of aluminum-based material and ABS. In one embodiment, the electronics housing 25 may be comprised of carbon fiber and/or titanium for aesthetic purposes. In some embodiments, a gripping component may be disposed on the electronics housing 25. For example, the gripping component may be comprised of rubber for ease of holding/gripping the work light 10. In one embodiment, indentations may be molded, or otherwise formed on the electronics housing 25 so as to facilitate grasping and handling the work light 10 in a user's hand.

In one embodiment, the electronics housing 25 may include a plurality of user controls 30, which may include a number of controls disposed in any of various configurations. For example, the user controls 30 may be disposed in a column configuration, or may be disposed in multiple columns and rows. Other configurations of the user controls 30 will be apparent to those skilled in the art. By way of non-limiting example, the user controls 30 may include an ON/OFF switch, a timer button so that the flexible work light remains ON for a predetermined period of time, and various operational modes which may be selected by the user depending on the nature of the work area. In one embodiment, at least one of the various operational modes may be configured to automatically increase the brightness of the work light 10 when insufficient lighting is detected. In one embodiment, the flexible work light 10 may include an independent control to increase or decrease the light output of the work light 10. In one embodiment, the user controls 30 comprise one or more dimmer functions to control the output of the work light 10.

In one embodiment, the flexible work light 10 comprises an elongate member 40 that is preferably substantially translucent. In one embodiment, the elongate member 40 takes the shape of a generally hollow tube, however any number of shapes and configurations are within the scope of the present disclosure. By way of non-limiting example, the elongate member 40 may take the shape of a cylinder, lantern, cube, candlestick, and the like. As those skilled in the art will appreciate, the length and width of the elongate member 40 may be varied depending on an intended use of the work light 10. For example, for outdoor applications, a thicker elongate member may be used to further protect the components housed therein. In other applications, thinner elongate members may be used. In industrial applications, the elongate member 40 may be configured to resemble the size of a typical fluorescent tube light, or even double or triple that length.

It will be appreciated that the elongate member 40 may be comprised of any combination of materials, so long as the elongate member 40 is capable of being bent, or shaped, to various desirable configurations and retain the configuration until being reshaped by the user. In one embodiment, the elongate member 40 may be manufactured from, for example, flexible polyvinyl chloride (PVC), epoxy, or a combination of the both. As will be appreciated by those skilled in the art, flexible PVC incorporates the use of plasticizers to make the material more flexible, and thus flexible PVC is particularly well suited for the elongate member 40. In some embodiments, the elongate member 40 may be comprised of a polyurethane or a rubber material. In one embodiment, the elongate member 40 may be comprised of thermoplastic elastomers (TPEs). TPEs represent a class of copolymers that typically provide the best characteristics of both rubber like materials and plastics. In some embodiments, the elongate member 40 may be comprised of a thermoplastic urethane (TPU). As those skilled in the art will appreciate, TPU is another type of thermoplastic elastomer that bridges the gap between plastics and rubber. Indeed, TPUs have excellent durability, strength and manufacturing qualities.

In some embodiments, the material comprising the elongate member 40 may comprise any number of filters so as to achieve a particular color or light output. In one embodiment, the elongate member 40 is completely transparent. In one embodiment, the elongate member 40 may have a coating, such as a phosphorous coating. In one embodiment, a shatter proof coating may be disposed on the elongate member 40. Any number of filters and or layers of coatings may be used to achieve a desired level of transparency of the elongate member 40 without deviating from the spirit and scope of the present disclosure.

Referring now to FIG. 1B, the work light 10 may be bent and thereby configured by a user to achieve a desired shape. In one embodiment, the work light 10 maintains the desired shape until the work light is reshaped by the user. As those skilled in the art will appreciate, maintaining a particular shape is useful for manipulating the work light 10 into tight, cramped work areas. For example, the flexible work light 10 may be configured to hang off of the hood of an automobile. In one embodiment, the flexible work like 10 can maintain a plurality of forms or shapes for the purposes of, by way of non-limiting example, hanging, maneuvering through tight work areas, affixing to ledges, hooks, hangers, and other obvious locations to affix a flexible work light. It will be appreciated that the flexible work light 10 advantageously allows for illumination of an area with the ability to manipulate the light source to any angle, size or direction, while holding a particular shape until manipulated again to another desired shape, angle or size by the user.

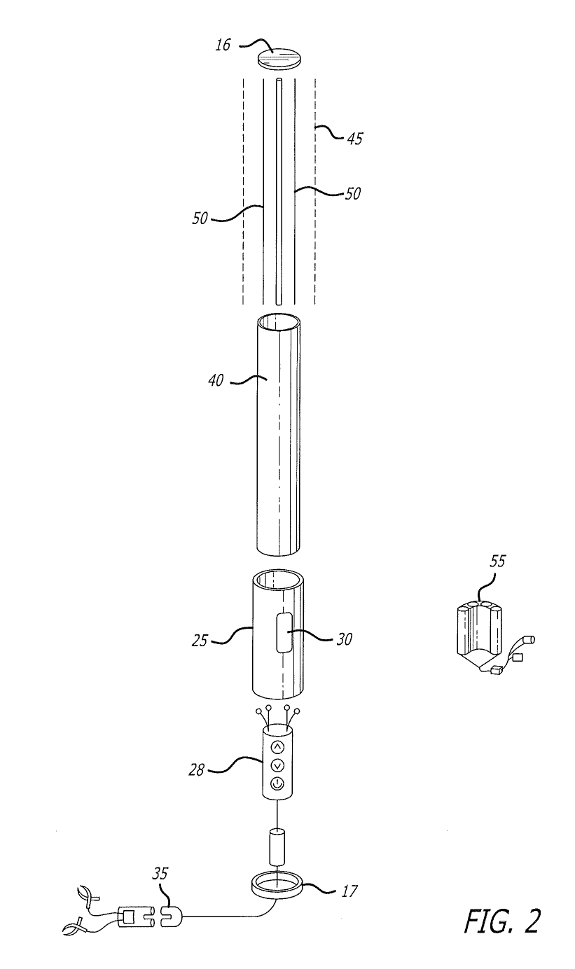

Referring now to FIG. 2, an exploded view of the work light 10 is shown. In one embodiment, the work light 10 comprises an electronics housing 25, an elongate member 40, an end cap 16, one or more support members 50, and one or more lighting sources 45. In one embodiment, the electronics 28 are housed within electronics housing 25. As shown in FIG. 2, power may be supplied to the work light 10 by way of an external power source, such as a 12V automobile battery, or by way of a battery 55 that may either be disposable or recharged, depending on the application. In one embodiment, the work light 10 includes one or more leads 35 that may be used to couple the work light 10 to an external power source. In one embodiment, the leads 35 may take the form of banana clips, however any other auxiliary connector or clip may be used to couple the leads to the external power source. In one embodiment, the work light 10 may be plugged into a wall socket so as to receive AC power. As shown in FIG. 2, it should be understood that the work light 10 is capable of being assembled and/or disassembled by a user with ease. Consequently, it is envisioned that the work light 10 may be part of a larger, modular lighting system that may combine one or more work lights 10, and/or combines any of the components as disposed therein.

In one embodiment, the electronics housing 25 is configured to allow removal of the leads 35, thereby increasing the portability of the flexible work light 10, such that it may be operated without being tethered to an external power source. As will be appreciated, removing the leads 35 increases the practicality of the work light 10, facilitating use of the work light in locations where external power is unavailable. In one embodiment, the work light 10 may include both the internal battery 55, as well as the functionality to connect to an external power source. In one embodiment, the internal battery 55 may be charged and thereby replenished by an external power source. As those skilled in the art will appreciate, the work light 10 may be powered by way of a variety of power sources, as well as combinations thereof, without limitation or deviating from the spirit and scope of the present disclosure.

In the embodiment illustrated in FIG. 2, the work light 10 further comprises the one or more support members 50 extending longitudinally within the electronics housing 25. In one embodiment, the support members 50 extend from the electronics housing 25 to the end cap 16. However, as those skilled in the art will appreciate, the support members 50 need not extend the full length of the elongate member 40, but rather may extend to a point proximal of the end cap 16. The support members 50 may be comprised of any material that is capable of flexure. In one exemplary embodiment, the support members 50 may be comprised of malleable aluminum. In one embodiment, the support members 50 may be made a steel flat. In one embodiment, the support member may be a wire. In one embodiment, the support members 50 may be attached to the electronics housing 25 and the end cap 16 via an epoxy, or any other suitable adhesive. In one embodiment, the light sources 45 may be attached to the support members 50 by way of an epoxy, or any other suitable adhesive. In one embodiment, the support members 50 are capable of bending along with the elongate member 40 so as to assume a desired shape. As those skilled in the art will appreciate, because the lighting sources 45 are disposed along with the support members 50, the lighting sources 45 bend with the elongate member 40. The result is a flexible work light 10 that is capable of maintaining the desired shape until reconfigured by a user. Furthermore, the lighting sources 45 and support members 50 are housed in and protected by the elongate member 40, such that the internal components are protected from environmental hazards, such as water, dust, or flammable materials. In one embodiment, the work light 10 may be further configured to be impact and/or shock resistant.

In one embodiment, the lighting sources 45 may comprise one or more light emitting diodes (LEDs) disposed in any number of different configurations. However, because the light produced by an individual LED is conventionally directional and focused, it is preferable to use a plurality of LEDs in the embodiments as discussed herein. Using arrays or groups of LEDs, as well as lenses or optics, a LED lighting product can provide light over a larger area, for either ambient or task functions. In general, LEDs are driven by constant current (350 mA, 700 mA or 1 A) drivers or constant voltage (10V, 12V or 24V) drivers. It is contemplated that constant current drivers may fix the current of and vary the voltage of embodiments as discussed herein, depending on the load of the LED. As most constant voltage drivers require a fixed voltage, the LED loads may be added in parallel across the output of their respective driver(s) until maximum or desired output currents are reached.

In one exemplary embodiment, the LEDs may take the form of LED strips, although the individual LEDs may take any form, size or color. As will be appreciated, the LEDs may be of the single-die, medium power variety, or may be high-power, as well as any combination thereof. In one embodiment, the LEDs may be a single color, such as by way of non-limiting example, red, green, blue, white (cold or warm), yellow, and the like. Preferably, the LED strips may be of a flexible variety. In one embodiment, the LED strips comprise an adhesive so that they may be disposed as required in the work light 10. In one embodiment, the LED strips may be analog, and thus have a single color which may be changed by way of a remote controller, or other equivalent mechanism. In yet another embodiment, the LED strips may be digital, such that the color of each individual LED may be changed so as to enable creating various screens and effects. As those skilled in the art will appreciate, any number of LEDs may be implemented on a particular LED strip. For example, LED strips typically comprise 30, 42, 60 or 120 LEDs per meter. It will be further appreciated that utilizing relatively more LEDs generates a higher intensity of smooth light.

In one embodiment, the lighting source 45 may comprise one or more fiber optic strips. In one embodiment, the lighting source 45 may include one or more side illumination fiber optic light guides. In one embodiment, the lighting source 45 may be a combination of various types of lighting sources. In some embodiments, fiber optic light guides may transmit light through glass optical fibers. As will be appreciated, fiber optic light guides collect light in a large acceptance angle, typically 82°, which is equivalent to a f/0.57 lens. As those skilled in the art will further appreciate, fiber optic light guides can transport light over complicated paths into remote areas, thereby saving weight, space, and manufacturing costs of the flexible work light 10.

In one embodiment, the lighting source 45 may comprise one or more flexible side glow fiber optic solid cores, which are well suited for linear fiber optic lighting applications such as neon replacement, cove lighting, accent lighting, as well as lighting a work area. As those skilled in the art will appreciate, side emitting solid core fiber cable is visually uniform and maintains a uniform color throughout its entire length. In one embodiment, both ends of the fiber cable may be connected to an illuminator. Flexible side glow fiber optic solid cores are a safe alternative to neon, and are particularly well suited for underwater and above ground applications. Moreover, flexible side glow fiber optic solid cores are ideal for projects in need of color changing lines because, unlike presently available wires, they carry no heat or electricity, thus making them relatively safe in a dangerous work environment.

In one embodiment, the lighting source 45 may include an exterior protective jacket. In some embodiments, a UV jacket comprising PVC and Teflon jacket over the center core may be used to protect the lighting source 45 from weather and sunlight damage. In one embodiment, the jacket may be treated with algaecide so as to protect the work light 10, and the user, from algae and fungus. It should be understood that any number of filters and protective jackets may be incorporated into the work light 10 and are within the scope of the present disclosure.

In one embodiment, the lighting source 45 may span the full length of the elongate member 40. In one embodiment, the lighting source 45 may span only a partial length of the elongate member. In some embodiments, various colors may be produced by the light source 45, such that a portion of the work light illuminates a first color, and a separate portion of the work light illuminates a second color different from the first color. The lighting sources 45 may be disposed at any angle and varying locations within the elongate member 40, such that the light source 45 remains undamaged when the work light 10 is configured into a particular shape.

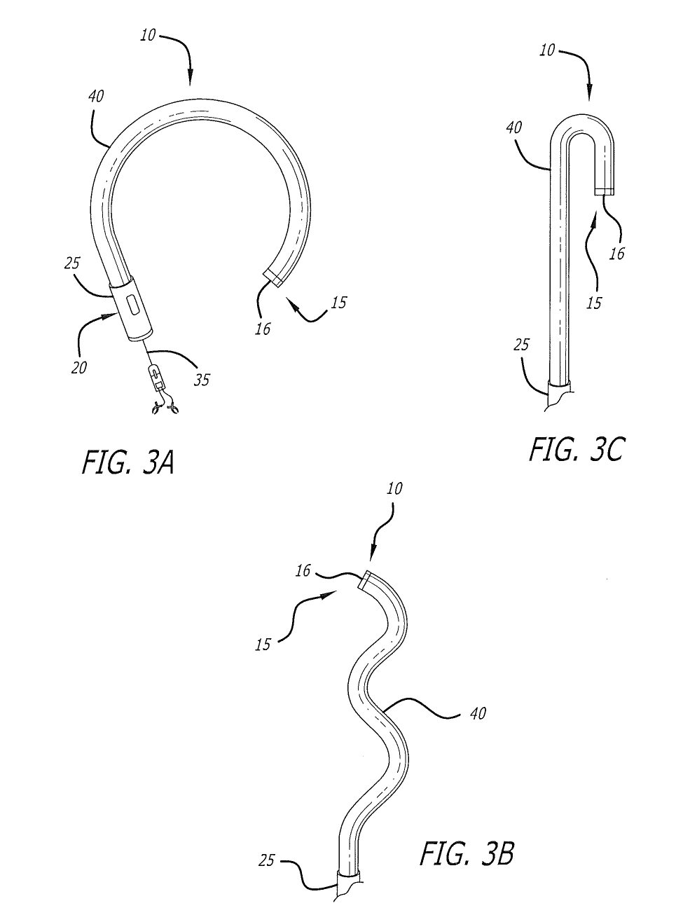

As shown in FIGS. 3A-3C, the work light 10 may be manipulated into a variety of different configurations. Specifically, FIG. 3A shows the work light 10 bent into an arc-shape having an angle of substantially 180 degrees, although any angle greater than or lesser than 180 degrees may be achieved and maintained by the work light 10. It will be appreciated that arc-shaped configurations are useful for hanging the work light 10 on a ledge, or illuminating a rounded work space. FIG. 3B shows the work light 10 configured into a sinusoidal shape, such that light may be emphasized at various points along the length of the work light 10. FIG. 3C shows a cane-shaped arrangement of the work light 10, such that the work light 10 may be hung from an open automobile hood, for example, or suspended from a ledge, or other similar protruding surface. Further, the work light 10 shown in FIG. 3C may be hung temporarily from a fixture attached to a roof of a facility, and re-shaped as needed.

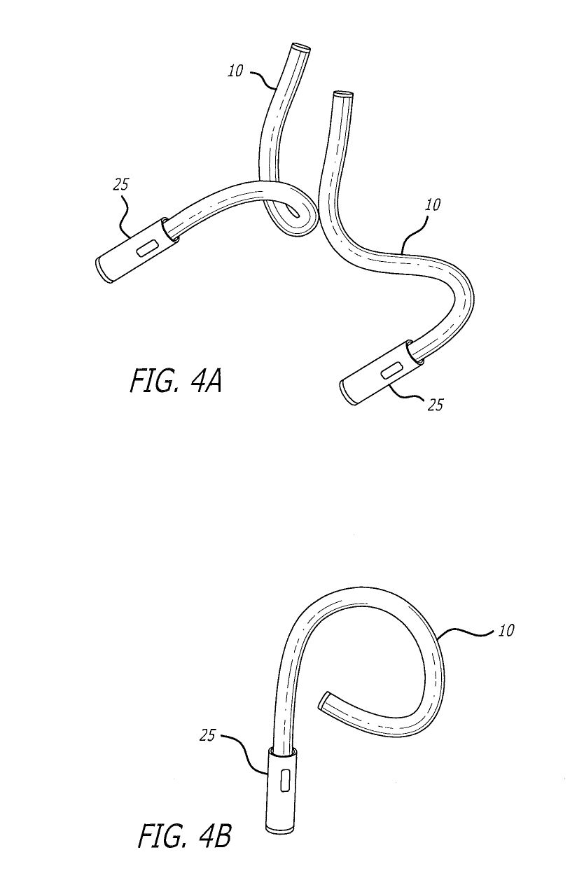

FIGS. 4A and 4B show implementations of the work light 10 comprising different lighting sources 45. FIG. 4A shows the work light 10 comprising a fiber optic light guide as the lighting source 45. As those having skill in the art will appreciate, the fiber optic light guide provides a diffused light output as compared to the embodiments using LEDs exclusively. FIG. 4B shows an exemplary implementation of the work light 10 wherein an LED strip is used as the lighting source 45. In the arrangement of FIG. 4B, each individual LED is more apparent as compared to the diffused light output of the fiber optic light guide shown in FIG. 4A. In both arrangements, however, the work light 10 may be configured into any desired shape by a user of the work light. Further, as those skilled in the art will appreciate, any combination of LEDs and fiber optic light guides may be disposed within the elongate member 40 so as to achieve any desired light output, color, power consumption rating, and the like.

While the invention has been described in terms of particular variations and illustrative figures, those of ordinary skill in the art will recognize that the invention is not limited to the variations or figures described. In addition, where methods and steps described above indicate certain events occurring in certain order, those of ordinary skill in the art will recognize that the ordering of certain steps may be modified and that such modifications are in accordance with the variations of the invention. Additionally, certain of the steps may be performed concurrently in a parallel process when possible, as well as performed sequentially as described above. To the extent there are variations of the invention, which are within the spirit of the disclosure or equivalent to the inventions found in the claims, it is the intent that this patent will cover those variations as well. Therefore, the present disclosure is to be understood as not limited by the specific embodiments described herein, but only by scope of the appended claims.

What is claimed:

1. A flexible work light, comprising:
an elongate member comprised of a translucent material capable of being shaped;
a lighting source housed within the elongate member;
one or more support members extending from a proximal portion to a distal position of the elongate member, the lighting source being attached to the one or more support members;
an electronics housing; and
an end cap disposed on a distal portion of the elongate member.

2. The flexible work light of claim 1, wherein the electronics housing comprises one or more user controls.

3. The flexible work light of claim 1, wherein the lighting source comprises a multiplicity of light emitting diodes (LEDs).

4. The flexible work light of claim 1, wherein the lighting source comprises a fiber optic light guide.

5. The flexible work light of claim 4, wherein the lighting source comprises a combination of LEDs and the fiber optic light guide.

6. The flexible work light of claim 1, wherein the support members are comprised of one or more steel flats.

7. The flexible work light of claim 1, wherein the support members comprise one or more wires.

8. The flexible work light of claim 1, further comprising an interface configured to couple the light source with an external power supply.

9. The flexible work light of claim 1, wherein the elongate member is comprised of PVC.

10. The flexible work light of claim 1, wherein the elongate member is comprised of epoxy.

11. The flexible work light of claim 1, wherein the elongate member, the one or more support members, and the lighting source are capable of being configured into various shape by a user, and maintaining each shape until reconfigured by the user.

12. A flexible work light, comprising:
an elongate member configured to be manipulated into a multiplicity of shapes;
a lighting source attached to one or more support members within the elongate member;
an electronics housing comprising at least one user control; and
an end cap disposed on a distal portion of the elongate member.

13. The flexible work light of claim 12, wherein the lighting source comprises a multiplicity of light emitting diodes (LEDs).

14. The flexible work light of claim 12, wherein the support members comprise one or more wires.

15. The flexible work light of claim 12, wherein the electronics housing comprises leads configured to be coupled to an external power source.

16. The flexible work light of claim 12, wherein the electronics housing comprises one or more internal batteries.

17. A method for a flexible work light, comprising:
providing a flexible elongate member;
adhering one or more lighting sources to one or more support members;
coupling the one or more lighting sources to circuitry within an electronics housing;
attaching the elongate member to the electronics housing; and
fastening an end cap to a distal end of the flexible elongate member.

18. The method of claim 17, wherein the flexible elongate member is comprised of PVC.

19. The method of claim 17, wherein the electronics housing includes one or more user controls.
